(19) United States
(12) Patent Application Publication
(10) Pub. No.: US 2009/0186418 A1
(43) Pub. Date: Jul. 23, 2009

(54) Test method and kit

(76) Inventor: David M. Lachance, Grand Bend (CA)

Correspondence Address: DAVID M. LACHANCE, 10397 GRAND OAKS DR, P.O. BOX 873, GRAND BEND - ONTARIO, N0M 1T0, CA

(21) Appl. No.: 12/157,938

(22) Filed: Jun. 16, 2008

(30) Foreign Application Priority Data
Jan. 17, 2008 (CA) 2617218

(51) Int. Cl. G01N 21/78; G01N 37/00

(52) U.S. Cl. 436/73; 422/61

(57) ABSTRACT

A test method and kit are disclosed. The method is for use with an object, said method comprising the steps of: (a) treating a surface of the object to expose an undersurface area; (b) exposing the undersurface to a sulfide; and (c) visually monitoring the appearance of the sulfide to which the undersurface was exposed for a color change. The color change is indicative of the presence or absence of lead in the object. The test kit can comprise: an abrasive material; a vessel containing a water soluble sulfide solution; a lead-free color comparison chart to which the color of the sulfide can be compared; and a confirmation strip adapted to cause said sulfide to undergo a color change, when exposed to said strip, at least similar to the color change that would be produced in the sulfide on exposure to lead.

### FIELD OF THE INVENTION

The present invention relates to the field of lead testing.

### BACKGROUND OF THE INVENTION

Although lead is poisonous to humans, it has been widely used in the past in industry, and it's use continues to be a tempting option to the unscrupulous industrialist.

It is known to test pottery and ceramic containers for leachable lead by filling said containers with liquids and testing the resultant solution for lead using a sulfide and a glycol. This is a useful test for pottery and ceramics, but can be time-consuming.

It is also known to test for lead, for example, in paint, by either portable x-ray fluorescence analyzers (XRF) or by laboratory analysis. XRFs are expensive to purchase, have radioactive sources, and operators must be trained and licensed. A laboratory analysis is time-consuming, and may also be very costly.

### SUMMARY OF THE INVENTION

A testing method for use with an object forms one aspect of the invention. The method comprises the steps of: (a) treating a surface of said object to expose an undersurface area; (b) exposing the undersurface to a sulphide; and (c) visually monitoring the appearance of the sulfide to which the undersurface was exposed for a color change. The color change is indicative of the presence or absence of lead in the object.

According to another aspect of the invention, in the method, in step (a), the surface can be physically treated by abrasion.

According to another aspect of the invention, in step (a), the surface can be physically treated by sanding.

According to another aspect of the invention, the color change can be indicative of the presence of lead in the object.

According to another aspect of the invention, in the event of a color change, the resultant color of the sulfide can be matched to the nearest one of a variety of colors on a lead-free color chart to produce a quantitative indication of the amount of lead released from the undersurface.

According to another aspect of the invention, when the method indicates the absence of lead, the sulfide can be exposed to a lead-free confirmation item, said lead-free confirmation item being adapted to cause said sulfide to undergo a color change, when exposed to said strip, at least similar to the color change that would be produced in the sulfide upon exposure to lead.

According to another aspect of the invention, the confirmation item can be produce a color in said sulfide, when exposed to said strip, which is indistinguishable from the color that would be produced in the sulfide upon exposure to lead.

According to another aspect of the invention, a color change to yellow, black or brown can be an indicator of the presence of lead.

According to another aspect of the invention, the sulfide can be provided in the form of a hydrous sulphide salt and water.

According to another aspect of the invention, the lead-free confirmation item can be a strip impregnated with a copper-based salt in a 2-5% concentration range.

A test kit forms another aspect of the invention. The test kit comprises: an abrasive material; and a vessel containing a test solution containing a supply of water soluble sulfide.

According to another aspect of the invention, the water soluble sulfide can be 5% sodium sulphide nona-hydrate in distilled water.

According to another aspect of the invention, the kit can further comprise a lead-free color comparison chart for comparison with the color produced after the addition of the test solution.

According to another aspect of the invention, the vessel can be high density polyethylene plastic or glass.

According to another aspect of the invention, the abrasive material can be sandpaper.

According to another aspect of the invention, the kit can further comprise a confirmation item adapted to cause said sulfide to undergo a color change, when exposed to said item, at least similar to the color change that would be produced in the sulfide on exposure to lead.

According to another aspect of the invention, the lead-free confirmation item can be a strip impregnated with a copper-based salt in a 2-5% concentration range.

According to another aspect of the invention, the sulfide can be selected from sodium, potassium, lithium, ammonium, calcium, strontium or barium sulphide or hydrosulphide.

According to another aspect of the invention, the sulfide can have a pH between about 11.7 and 12.9.

According to another aspect of the invention, the salt can be selected from sodium salt, disodium salt, potassium salt and combinations thereof.

The method permits a rapid determination as to the presence of lead in household items and other media. The kit is inexpensive and adapted to permit the practice of the method.

### DETAILED DESCRIPTION

A test kit forms an exemplary embodiment of the invention and comprises a supply of abrasive material, a vessel, a color comparison chart, a supply of confirmation items and a fluid transfer device.

The abrasive material is 200 grit sandpaper.

The vessel is made of high density polyethylene plastic and contains a supply of a test solution, specifically, 5% sodium sulphide nona-hydrate in distilled water, at a pH of 12.5

The color chart shows a variety of colors [indicated with reference to the CMYK color code system], each corresponding to a lead concentration, specifically:

| COLOUR | C | M | Y | K | PPM |
|---|---|---|---|---|---|
| Faint yellowish tint | 3.92 | 1.18 | 19.61 | 0 | 1-3 |
| Light brown | 16.08 | 24 | 77.25 | 4.31 | 5 |
| Medium brown | 28.63 | 45.88 | 70.98 | 15.69 | 10 |
| Dark Brown | 0 | 36 | 84 | 62 | 25 |
| Black | 0 | 0 | 0 | 100 | 50+ |

The confirmation items take the form of paper strips, impregnated with copper sulfate in a 2-5% concentration range.

The fluid transfer device in the exemplary embodiment takes the form of an eyedropper.

To use the kit to test for the presence of lead in an object, a small sample (1-2 cm diameter) of the object to be tested (eg. a paint chip) is sanded lightly with the abrasive to expose an undersurface area. Thereafter, 2-4 drops of the test solution are applied to the undersurface with the eyedropper, and the appearance of the sulfide is visually monitored for 15-30 seconds.

If the sulfide changes color, lead is indicated to have been released from the object, and the color of the sulfide can be matched to the nearest one of the variety of colors on the color chart, which match is indicative of the amount of lead released from the undersurface.

If the sulfide does not undergo a noticeable color change within 30 seconds, lead is indicated to be absent. To confirm this negative indication, a drop of the sulfide from the eyedropper is deposited onto the confirmation strip. If the sulfide on the confirmation strip changes color, the sulfide remains viable and the negative indication is confirmed. If the sulfide does not undergo a color change, the sulfide can be presumed to have lost reactivity, in which case, a fresh supply of the sulfide needs to be procured, and the test repeated.

Whereas but a single embodiment of the kit and method performed therewith are herein described, it will be evident that various modifications are possible.

For example, whereas sodium sulfide nonahydrate is described, the sulphide could also be potassium, lithium, ammonium, calcium, strontium or barium sulphide or hydrosulphide.

As well, whereas 5% sodium sulfide nonahydrate is described, solutions consisting of 1%, 2%, 3%, 5%, 10% and 25% sodium sulfide nonahydrate, with pH values ranging from 11.7 to 12.9, also work.

Additionally, whereas the sodium sulfide solution described is formed from the addition of distilled water, de-ionized water could also be used.

Moreover, the salts include but are not limited to sodium salt, disodium salt, and potassium salts.

Yet further, whereas an eyedropper is described, cotton swabs could also be used, and rubbed on the surface to be tested and, in the absence of an indication for lead, on the confirmation strip.

As well, whereas a HDPE bottle for the vessel is taught, glass could similarly be used. Sulfide will migrate quickly out of a LDPE bottle, and thus, use of such a bottle will deleteriously impact on shelf life of the test kit.

It is preferred that the kit not contain any lead as various countries ban the use of lead in products that are sold to consumers. However, the confirmation strips could have lead content.

In view of these potential variations, the invention should be understood to be limited only by the accompanying claims, purposively construed.

1. A testing method for use with an object, said method comprising the steps of:
(a) treating a surface of said object to expose an undersurface area;
(b) exposing the undersurface to a sulphide; and
(c) visually monitoring the appearance of the sulfide for a color change,
wherein said color change is indicative of the presence or absence of lead in the object.

2. A method according to claim 1, wherein in step (a), the surface is physically treated by abrasion.

3. A method according to claim 1, wherein in step (a), the surface is physically treated by sanding.

4. A method according to claim 1, wherein the color change is indicative of the presence of lead in the object.

5. A method according to claim 1, wherein, in the event of a color change, the resultant color of the sulfide is matched to the nearest one of a variety of colors on a lead-free color chart to produce a quantitative indication of the amount of lead released from the undersurface.

6. A method according to claim 1, wherein, when the method indicates the absence of lead, the sulfide can be exposed to a lead-free confirmation item, said lead-free confirmation item being adapted to cause said sulfide to undergo a color change, when exposed to said strip, at least similar to the color change that would be produced in the sulfide upon exposure to lead.

7. A method according to claim 6, wherein said lead-free confirmation item is being adapted to cause said sulfide to undergo a color change, when exposed to said strip, which is indistinguishable from the color that would be produced in the sulfide upon exposure to lead.

8. A method according to claim 7, wherein a color change to yellow, black or brown is an indicator of the presence of lead.

9. A method according to claim 1, wherein the sulfide is provided in the form of a hydrous sulfide salt and water.

10. A method according to claim 5, wherein the lead-free confirmation item is a strip impregnated with a copper-based salt in a 2-5% concentration range.

11. A test kit comprising:
an abrasive material; and
a vessel containing a water soluble sulfide test solution.

12. A kit according to claim 11, wherein the water soluble sulfide is 5% sodium sulphide nona-hydrate in distilled water.

13. A kit according to claim 11, further comprising:
a lead-free color comparison chart for comparison with the color produced after the addition of the test solution.

14. A kit according to claim 11, wherein the vessel is high density polyethylene plastic or glass.

15. A kit according to claim 11, wherein the abrasive material is sandpaper.

16. A kit according to claim 13, further comprising
a lead-free confirmation item adapted to cause said sulfide to undergo a color change, when exposed to said item, at least similar to the color change that would be produced in the sulfide upon exposure to lead.

17. A kit according to claim 16, wherein the lead-free confirmation item is a strip impregnated with a copper-based salt in a 2-5% concentration range.

18. A kit according to claim 11, wherein the sulfide is selected from sodium, potassium, lithium, ammonium, calcium, strontium or barium sulphide or hydrosulphide.

19. A kit according to claim 11, wherein the sulfide has a pH between about 11.7 and 12.9

20. A kit according to claim 11, wherein the salt is selected from sodium salt, disodium salt, potassium salt and combinations thereof.
